(19) United States
(12) Patent Application Publication
(10) Pub. No.: US 2026/0012786 A1
(43) Pub. Date: Jan. 8, 2026

(54) HOME NETWORK CONTROLLED AUTHENTICATION

(71) Applicant: TELEFONAKTIEBOLAGET LM ERICSSON (PUBL), STOCKHOLM (SE)

(72) Inventors: David Castellanos Zamora, Madrid (ES); Vlasios Tsiatsis, Stockholm (SE); Cheng Wang, Shanghai (CN); Jesús Ángel De Gregorio Rodriguez, Madrid (ES); Vesa Lehtovirta, Espoo (FI)

(21) Appl. No.: 19/118,315

(22) PCT Filed: Oct. 3, 2023
(86) PCT No.: PCT/IB2023/059885

§ 371 Date: Apr. 3, 2025

(30) Foreign Application Priority Data
Oct. 3, 2022 (WO) PCT/CN2022/123678

(51) Int. Cl. H04W 12/06

(52) U.S. Cl. CPC H04W 12/06

(57) ABSTRACT

A method performed by a Unified Data Management (UDM) comprises determining that a user equipment (UE) has been registered in the UD.M by an Access and Mobility Management Function (AMP), in response to the determination, sending a request message to the AMP to initiate a primary authentication procedure for the UE, wherein the request message includes a subscription permanent identifier (SUPI) associated with the UE, and receiving a response message from the AMP based on the request message. wherein the response message indicates an authentication status of the UE.

### BACKGROUND

The current 5G security specification in 3GPP Technical Specification (TS) 33.501 describes a user equipment (UE) authentication procedure as initiated by the serving network for example upon UE registration. The authentication in turn results in a key (K_{AUSF}) shared between the UE and the Home Network. This key is used in several Home Network procedures (i.e., procedures between the UE and the Home Network/HPLMN) such as Steering of Roaming (SoR), UE Parameter Update (UPU) and Authentication and Key Management for Applications (AKMA) using 3GPP credentials in 5G.

The primary authentication in the current 3GPP specification is always initiated by the serving network (AMF). The AMF typically initiates a primary authentication when it does not have the UE context (e.g., UEID=SUPI, Mobility Management context) and when it cannot retrieve the UE context from another AMF which could have the UE context. In certain cases of interworking (UE moves from EPS to 5GS, or 4G to 5G) the AMF may obtain the UE context from EPS but may not initiate primary authentication. In the case that the AMF has the UE context, whether or not the AMF initiates primary authentication is determined by local serving network policy.

The study Home Network triggered primary authentication (3GPP Technical Report [TR] 33.741) studies procedures for enabling the Home Network to trigger primary authentication upon certain conditions. There are three use cases for a Home Network triggered primary authentication: Interworking, SoR/UPU counter wrap-around, AKMA.

There currently exist certain challenges. There are three use cases in the study of Home Network triggered primary authentication (TR 33.741) that motivate the introduction of the Home network controlled or initiated primary authentication as opposed to the existing serving network initiated authentication.

The three use cases are the following:
1. Interworking: The UE is in a 4G network and moves to a 5G network for the first time. Because the serving 5G network may not have performed an authentication before this event, the UE and the network do not share any K_{AUSF}. The K_{AUSF} may be needed for SoR/UPU or AKMA procedures which will fail due to the lack of K_{AUSF}. It is claimed in the study that the Home Network does not have way to trigger a primary authentication to generate a K_{AUSF}. However, there is existing specification to support this use case by the Home network returning a REAUTHENTICATION_REQUIRED response to the serving network when the serving network attempts to register itself to the Home network UDM (User Data Management network function).
2. SoR/UPU counter wrap-around. The SoR/UPU procedures make use of 16-bit counters for the proper operation of the SoR/UPU features. If the counters reach their maximum value, they cannot be reset unless there is a new primary authentication. The SoR/UPU procedures are controlled by the Home network which does not currently have any control of initiating a primary authentication.
3. The AKMA application function (AF) key (K_{AF}) between a UE and an application function is derived from the AKMA key (K_{AKMA}) which in turn is derived from the K_{AUSF} upon primary authentication. If the K_{AUSF} is not refreshed then the K_{AKMA} and K_{AF} are not refreshed either. This situation may be undesirable for certain applications. The AKMA feature is also a feature supported the Home Network and the UE and the Home Network currently does not have a way to initiate primary authentication and refresh the K_{AUSF}, K_{AKMA} and K_{AF}.

For these use cases and potentially other future use cases it may be desirable for the Home Network to be able to trigger primary authentication in order to control the refresh of the K_{AUSF}.

### SUMMARY

Certain aspects of the disclosed subject matter may provide solutions to the above and/or other challenges. The present disclosure explores one other aspect of the problem of Home Network triggered primary authentication. Instead of the Home network initiating a primary authentication, the Home network requests from the serving network to delay its authentication policy and initiate primary authentication until time instants that the Home Network requests.

Certain aspects of the current disclosure build upon one or more of the following concepts.
1. The Home network (e.g. UDM) maintains a per-UE (re-)authentication policy potentially per access type (3GPP, non-3GPP) including information whether the UE needs to be (re-)authenticated and optional information about a point in time in the future that such an (re-)authentication is needed, if the UE needs periodic authentication, for which use case (interworking, SoR/UPU counter wrap-around, AKMA, others) the UE re-authentication policy should be applied. This new information could be added and related to the authentication status of the UE. This information can be provided to the serving network and can be incorporated to the UE security context maintained by the AMF. As part of the security context this information can be transferred from AMF to AMF when the UE is not reachable by the last serving AMF. The first AMF which receives the security context which indicates the re-authentication is required, initiates authentication according to the information in the security context e.g., as soon as possible (in order for this to be practically implementable the future point in time way could be applied with a close point in time), in a future point in time, upon the reception of certain event/message e.g., a registration request. The UDM can clear the need for re-authentication when it receives an event that the UE is successfully authenticated or internal policy condition changes e.g., timer expires.
2. The Home network maintains also HPLMN-wide home network triggered authentication policy (information about a time point in the future to trigger the primary authentication or the period of periodic authentication, the type of use cases such a procedure could be enabled etc.). This information is called a policy in this context, but it could be called with any other name. Characterizing this information as “policy” or “per-UE policy” could be implemented as a structure of information pieces with a collective name “per-UE authentication policy” or a logical grouping of pieces of information with the logical name “per-UE authentication policy”.
3. Embodiments can also include handling of the policy enforcement on the HPLMN (Home Public Land Mobile Network) and VPLMN (Visitor Public Land Mobile Network). The policy can be in general shared between the HPLMN and VPLMN for example the policy could be forwarded from the HPLMN to the VPLMN so that the VLPLN can enforce the policy as opposed to the HPLMN. This is useful if the HPLMN does not support any Home Network triggered primary authentication. Policy from HPLMN to VPLMN could include timing information so that the AMF can have some time before it initiates a primary authentication as opposed to doing it immediately.
4. The behavior of other features or policies can be determined by the HPLMN-wide Home Network authentication policy or the UE-specific Home network authentication policy. An example of a feature is AKMA where the expiry time of the AKMA KAF is dependent on the timing information of the Home network authentication policy, for example the KAF expiry time could be set to the re-authentication time+X (sec). Another example, the SoR/UPU reauthentication trigger could be a specific SoR/UPU counter value with the semantics that the UE needs to be authenticated when the SoR/UPU value reaches the specified value.

If the HPLMN supports a Home Network triggered primary authentication the home network (e.g., UDM) can enforce the Home network authentication policy and initiate authentication when reacting to events from other Network Functions (NF e.g. AMF requests or notifications) or take some action based on timers etc.

Certain embodiments may provide one or more of the technical advantage(s) described in the present disclosure. Under certain embodiments, for example, advantages include the use of one UDM policy to determine the behavior of the network, in a PLMN-wide or per-UE basis which can be transferred to other network functions and determine the behavior of other network functions apart from the UDM.

In some embodiments of the disclosed subject matter, a method performed by a Unified Data Management (UDM) comprises determining that a user equipment (UE) has been registered in the UDM by an Access and Mobility Management Function (AMF), in response to the determination, sending a request message to the AMF to initiate a primary authentication procedure for the UE, wherein the request message includes a subscription permanent identifier (SUPI) associated with the UE, and receiving a response message from the AMF based on the request message, wherein the response message indicates an authentication status of the UE.

In certain related embodiments, the request message comprises a re-authentication notification.

In certain related embodiments, the request message further comprises a per-UE authentication policy.

In certain related embodiments, the response message indicates whether the UE is reachable by the AMF.

In certain related embodiments, method further comprises performing operations for the primary authentication procedure.

In certain related embodiments, 6. The method of any of the previous claims, wherein the UDM determines to initiate the primary authentication based on a Home Network policy.

In certain related embodiments, 7. The method of any of the previous claims, wherein the UDM determines to initiate the primary authentication in response to determining that the UE is not already engaged in a primary authentication procedure.

In certain related embodiments, 8. The method of any of the previous claims, wherein the UDM is associated with a 5G Core (5GC), and the UE is a 5G compliant UE.

In some embodiments of the disclosed subject matter, a Unified Data Management (UDM) comprises processing circuitry, memory, and transceiver circuitry collectively configured to perform operations comprising determining that a user equipment (UE) has been registered in the UDM by an Access and Mobility Management Function (AMF), in response to the determination, sending a request message to the AMF to initiate a primary authentication procedure for the UE, wherein the request message includes a subscription permanent identifier (SUPI) associated with the UE, and receiving a response message from the AMF based on the request message, wherein the response message indicates an authentication status of the UE.

In certain related embodiments, the request message comprises a re-authentication notification.

In certain related embodiments, the request message further comprises a per-UE authentication policy.

In certain related embodiments, the response message indicates whether the UE is reachable by the AMF.

In certain related embodiments, the operations further comprise performing operations for the primary authentication procedure.

In certain related embodiments, the UDM determines to initiate the primary authentication based on a Home Network policy.

In certain related embodiments, the UDM determines to initiate the primary

authentication in response to determining that the UE is not already engaged in a primary authentication procedure.

In some embodiments of the disclosed subject matter, a method of operating an Access and Mobility Management Function (AMF) comprises receiving a request message from a Unified Data Management (UDM) to initiate a primary authentication procedure for a user equipment (UE), wherein the request message includes a subscription permanent identifier (SUPI) associated with the UE, determining whether to perform the primary authentication procedure, and sending a response message to the UDM based on the request message, wherein the response message indicates an authentication status of the UE.

In certain related embodiments, the request message comprises a re-authentication notification.

In certain related embodiments, the request message further comprises a per-UE authentication policy.

In certain related embodiments, determining whether to perform the primary authentication procedure comprises determining whether the UE is reachable by the AMF.

In certain related embodiments, determining whether to perform the primary authentication procedure comprises inspecting a mark indicating whether the UE is to be authenticated.

In certain related embodiments, the method further comprises, upon determining that the primary authentication procedure is to be performed, initiating primary authentication with the UE, and thereafter sending the response message to the UDM to indicate the authentication status of the UE.

In some embodiments of the disclosed subject matter, a method of operating an Access and Mobility Management Function (AMF) comprises receiving a request message from a Unified Data Management (UDM) to initiate a primary authentication procedure for a user equipment (UE), wherein the request message includes a subscription permanent identifier (SUPI) associated with the UE, determining whether to perform the primary authentication procedure, and sending a response message to the UDM based on the request message, wherein the response message indicates an authentication status of the UE.

In certain related embodiments, the request message comprises a re-authentication notification.

In certain related embodiments, the request message further comprises a per-UE authentication policy.

In certain related embodiments, determining whether to perform the primary authentication procedure comprises determining whether the UE is reachable by the AMF.

In certain related embodiments, determining whether to perform the primary authentication procedure comprises inspecting a mark indicating whether the UE is to be authenticated.

In certain related embodiments, the operations further comprise, upon determining that the primary authentication procedure is to be performed, initiating primary authentication with the UE, and thereafter sending the response message to the UDM to indicate the authentication status of the UE.

### BRIEF DESCRIPTION OF THE DRAWINGS

The drawings illustrate select embodiments of the disclosed subject matter.

FIG. 1 illustrates an embodiment of UDM triggered primary authentication during UE Registration in accordance with some embodiments.

FIG. 2 illustrates a procedure for UDM to trigger primary authentication after UE Registration in accordance with some embodiments.

FIG. 3 illustrates a KAF refresh use case when primary authentication after UE Registration cannot be triggered in accordance with some embodiments.

FIG. 4 illustrates a flow-chart of UDM Triggered primary authentication after UE Registration in accordance with some embodiments.

FIG. 5 shows an example of a communication system in accordance with some embodiments.

FIG. 6 shows a UE in accordance with some embodiments.

FIG. 7 shows a network node in accordance with some embodiments.

FIG. 8 is a block diagram of a host in accordance with some embodiments.

FIG. 9 is a block diagram illustrating a virtualization environment in accordance with some embodiments.

FIG. 10 shows a communication diagram of a host in accordance with some embodiments.

### DETAILED DESCRIPTION

Some embodiments are described below with reference to the accompanying drawings. These embodiments are presented by way of example to convey the scope of the subject matter to those skilled in the art.

The three use cases studied in the 3GPP Home network triggered authentication (HONTRA) study (Interworking, SoR/UPU counter wrap-around, KAKMA refresh) are different with respect to whether the UE is being registered or whether the UE has already registered to 5GC. Therefore, there are two main architectural patterns which could be used for the application of HONTRA or equivalent procedures to solve a potential need for the three use cases. In the first pattern the UDM uses existing procedures to trigger primary authentication under UE registration while in the second pattern the UDM triggers a new procedure after the UE is already registered to the 5GC.

### Embodiment 1: UDM Triggered Primary Authentication During UE Registration

The procedure for UDM triggered primary authentication during UE Registration proposed in certain embodiments incorporates aspects of existing procedures already defined in TS 33.501, TS 23.502, and TS 29.503.

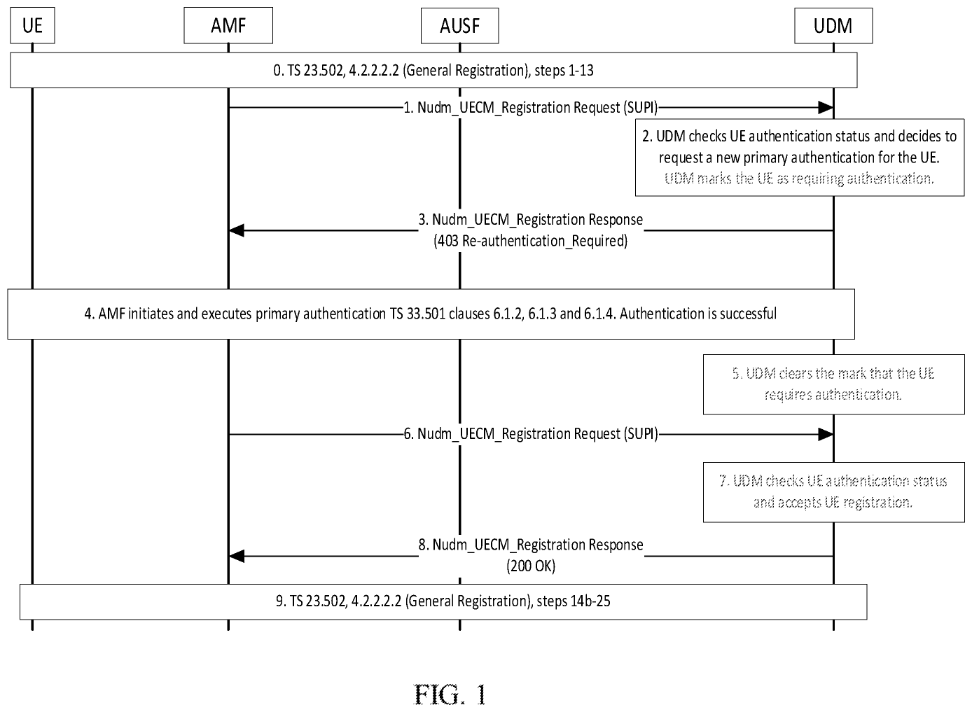

FIG. 1 illustrates an embodiment of UDM triggered primary authentication during UE Registration. The method steps of this embodiment can include the following:
0. The Registration procedure as in TS 23.502, clause 4.2.2.2.2, steps 1-13.
1. During UE registration in AMF, the AMF triggers Nudm_UECM_Registration service operation to register the UE in the UDM.
2. The UDM checks the authentication status and decides to request a new primary authentication for the UE. Refer to TS 33.501, clause 6.1.4.2 for more details regarding when UDM may take this decision. The UDM marks the UE as requiring primary authentication. The UDM may mark this information in the per-UE Home Network authentication policy. In this specific case the action taken by the UDM upon the per-UE policy change (UE is marked to be authenticated) and given the context (the AMF registers itself to the UDM as the one to serve the specific UE) is to respond to the serving network with an indication that a UE re-authentication is required. Another potential type of action could be an explicit event/message to the AMF to trigger primary authentication, see Embodiment 2, below.
3. UDM rejects the Nudm_UECM_Registration service operation with a RE_AUTHENTICATION_REQUIRED error as defined in TS 29.503.
4. The AMF then initiates the primary authentication procedure as defined in TS 33.501, clause 6.1.2. The primary authentication is executed according to TS 33.501, clauses 6.1.3 and 6.1.4. The primary authentication is successful.
5. Upon successful primary authentication, the UDM clears the mark that the UE requires authentication. This clearing of the UE mark could be done in the per-UE policy.
6. The AMF repeats the Nudm_UECM_Registration service operation to register the UE in the UDM.
7. The UDM checks the authentication status and now decides that the AMF registration can be accepted.
8. The UDM accepts the AMF Registration.
9. The Registration procedure as in TS 23.502, clause 4.2.2.2.2, steps 14b-25.

See description of Interworking Use Case, below, for more details on how this procedure can be applied to cover the interworking use case for the study of Home Network triggered primary authentication.

### Embodiment 2: UDM Triggered Primary Authentication After UE Registration

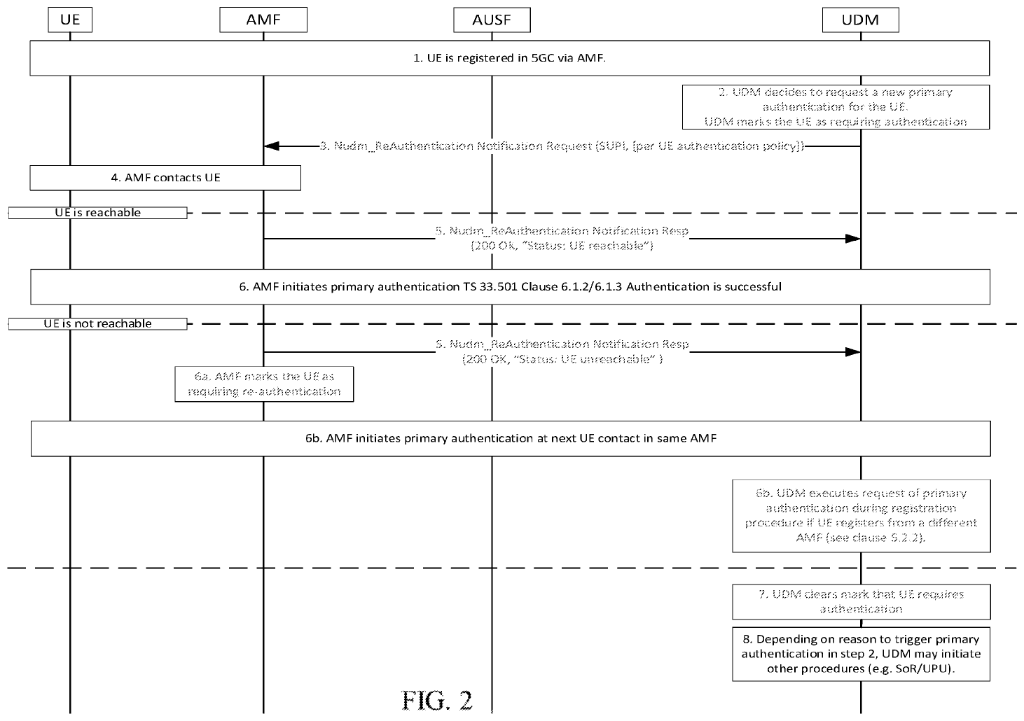

A second embodiment under the present disclosure includes a procedure for UDM to trigger primary authentication after UE Registration. A process flow illustrating this procedure is depicted in the following description and FIG. 2. The method steps of this embodiment can include the following:
1. The UE is registered in the 5GC via an AMF. The AMF has registered the UE in UDM. The AMF may have authenticated the UE or may have reused an authentication context from another AMF (or MME). The UDM keeps a time stamp of the latest UE authentication in 5GC (refer to TS 33.501 clause 6.1.4).
2. The UDM decides that the UE needs to be authenticated. It marks the per-UE authentication policy that the UE needs to be authenticated and takes the action to request a new primary authentication procedure for the UE towards the AMF. The reasons for the UDM deciding that the UE needs to be authenticated can be different:
   a. The UDM is required to initiate a SoR/UPU procedure for the UE, but it detects that the corresponding Counters have wrapped-up or are about to wrap-up. See further description below regarding the SoR/UPU wrap-up use case for more details on how this procedure can be applied to cover that situation.
   b. The UDM enforces a Home Network policy to refresh primary authentication over a given access type after a selected period of time and that time (based on the time stamp of latest authentication kept in UDM) has expired for the UE. See further description below regarding the KAF refresh use case for more details on how this procedure can be applied to cover that situation.
3. Unless the UE is already engaged in a primary authentication procedure already, UDM requests the AMF to trigger a primary authentication procedure for the UE by sending a re-authentication notification to the AMF. The UDM may include the per-UE authentication policy which indicates the marking that the UE needs to be authenticated. The per-UE authentication policy may include timing information about e.g., when the AMF could initiate primary authentication at the latest. If multiple AMFs are registered in UDM, the UDM selects and notifies one AMF first and if primary authentication fails, UDM may also notify the other AMF based on local policies. This embodiment proposes that the new service operation is modelled as a notification operation within the set of services offered by UDM; i.e. a Nudm service operation. It should be noted that which is the most appropriate alternative to model the re-authentication notification can be agreed with CT4 during normative phase.
4. Before acknowledging the ReAuthentication notification, the AMF should first check if the UE can be contacted to execute the requested primary authentication procedure.
5. The AMF replies to the ReAuthentication Notification with a successful response including the status information (if the UE is reachable or not).
6. If the UE is reachable, the AMF then initiates the primary authentication procedure as defined in TS 33.501, clause 6.1.2. The primary authentication is executed according to TS 33.501, clause 6.1.3 and 6.1.4. The primary authentication is successful. Otherwise, if the UE cannot be reached, the AMF marks the UE as requiring authentication or stores the per-UE authentication policy in the UE security context if sent in Step 3 and:
   a. Upon next UE contact in the same AMF, the AMF shall then trigger the primary authentication procedure potentially after consulting the per-UE authentication policy stored in the UE security context.
   b. Upon UE registration in UDM via a different AMF, if the new AMF does not authenticate the UE prior to the AMF registration, the UDM shall then reject the AMF registration with a Re-Authentication Required error as described in 33.501 TS clause 5.2.2. If the new AMF is able to retrieve the UE security context from the old AMF. the security context may include e.g., as part of the UE authentication policy the indication that the UE needs to be authenticated (this indication was based on the old AMF actions or an indication from the HPLMN UDM to the VPLMN AMF), and potentially time information (e.g., by when the UE should be authenticated). The new AMF may act on this information and initiate primary authentication. Otherwise, the new AMF registration to the UDM will trigger the UDM to act and initiate authentication as described in regard to Embodiment 1, above.
7. After the primary authentication is successfully completed, the UDM clears the mark that UE requires primary authentication the per-UE authentication policy.
8. The UDM may execute other procedures (e.g., SoR/UPU) depending on the reason that motivated the UDM triggered reauthentication procedure in step 2.

### Applicability of the UDM Triggered Primary Authentication Procedures to Several Use Cases

UDM triggered primary authentication procedures can now be discussed in relation to several use cases.

### Interworking Use Case

The UDM triggered primary authentication procedure during registration as described in relation to Embodiment 1, above, can be used by the Home Network to initiate primary authentication during the interworking use case. Such embodiments can make use of existing procedures, and no normative work is required to support this use case.

### SoR/UPU Wrap Around Use Case

The UDM triggered primary authentication procedure after registration as described relating to Embodiment 2 can be used by the Home Network to initiate primary authentication during the SoR/UPU wrap around use case.

The UDM can detect that the SoR/UPU Counters has wrapped-up or are about to wrap-up during the execution of the corresponding services in AUSF. The UDM receives the value of the Counters from AUSF so UDM can detect when the Counter are about to wrap up. Ultimately, the AUSF provides a Counter wrap up error to UDM when the counters wrap up. Based on local policy, the UDM can then request the AMF to trigger a primary authentication procedure for the UE.

After the primary authentication is successfully completed, the UDM can trigger the SoR/UPU procedure if needed.

If the primary authentication cannot be initiated by the AMF after being requested by the UDM (e.g., in case the UE is not reachable at that time), the UDM is informed by the AMF in the result of the reauthentication notification. In this case, the UDM marks the UE as requiring re-authentication and suspends the SoR/UPU service for the UE until the UE is authenticated again.

### Home Network Triggered Primary Authentication for KAF Refresh

The UDM triggered primary authentication procedure after registration as described in relation to Embodiment 2 can be used to ensure that there is fresh KAUSF/KAKMA key available in the Home Network for the KAF refresh use case.

The UDM can enforce a Home Network authentication policy to rn primary authentication after a selected period of time, i.e., TAuth. If the AAnF (AKMA Anchor Function) also enforces a related AKMA Home Network policy so that the expiry time for K_{AF} is set to a value greater than TAuth (i.e. TAuth+x), then the Home Network ensures that when a K_{AF} needs to be refreshed, it will be refreshed using a different K_{AKMA}.

If the primary authentication cannot be initiated by the AMF after being requested by the UDM (e.g. in case the UE is not reachable at that time), the UDM is informed by the AMF in the result of the reauthentication notification. In this case, the UDM marks the UE as requiring re-authentication in the per-UE authentication policy and requests the AAnF to remove the AKMA context for the UE by using the existing Naanf_AKMA_ContextRemove service operation. Based on this, the AAnF will not refresh the K_{AF}.

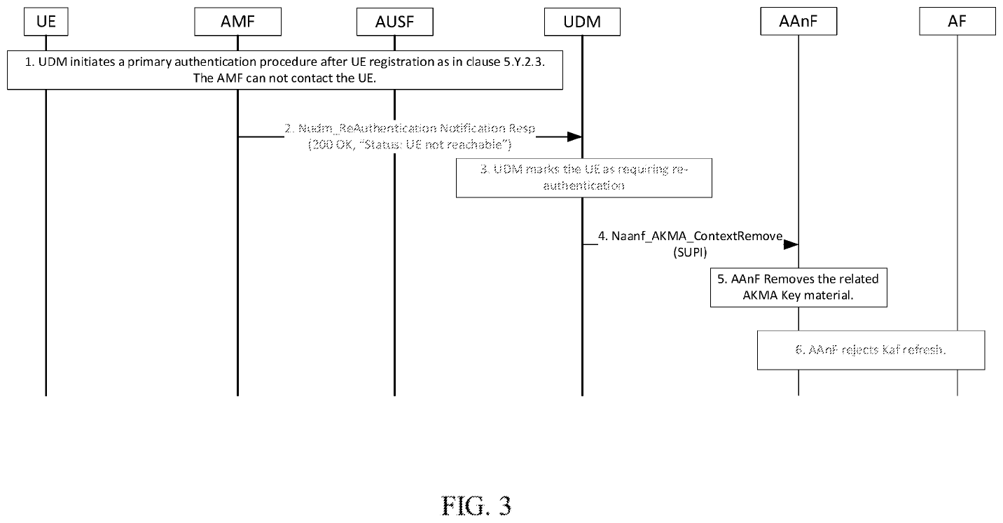

FIG. 3 helps to illustrate a process flow of this use case. FIG. 3 illustrates a KAF refresh use case when primary authentication after UE Registration cannot be triggered.

### Home Network Triggered Primary Authentication for KAF Refresh

The UDM triggered primary authentication procedure after registration as described in relation to Embodiment 2 can be used to ensure that there is fresh KAUSF/KAKMA key available in the Home Network for the KAF refresh use case.

A new notification service offered by UDM can be introduced, e.g., a default callback URI is included in UDM NF profiles registered in NRF (Network Repository Function). This notification URI enables the other NFs, in this case AAnF, to inform UDM that a fresh UE primary authentication is needed.

Based on local policy and authorization of the request, the UDM can decide whether a primary authentication procedure for the UE shall be triggered towards AMF as described in relation to Embodiment 2.

### Embodiment 3: Home Network (HPLMN) Delegates in Serving Network (VPLMN) the Enforcement of its Home Network Authentication Policy

One aspect of Embodiment 3 can include the HN delegating the enforcement of its HN authentication policy to the serving network. The serving network can be made aware of the HN authentication policy as part of the SLA agreements with each roaming partner. In this case, the HN authentication policy applies to all users of the HN equally.

Alternatively, this embodiment can comprise the HN providing the HN authentication policy to the serving network via an online method using SBA interactions. The HN authentication policy could be then provided to the serving network either:
1. In the response to the authentication request to the AMF (Nausf_UEAU_Authenticate Response).
2. In the response to the AMF registration in UDM (Nudm_UECM_Registration Response).
3. Included as Subscription Data provided to the AMF during registration (Nudm_SDM_Get Response. The HN authentication policy could be defined as a new IE within the Access and Mobility Subscription Data or as a separated independent Data subtype requested explicitly by the AMF.
4. In a new service/service operation between AMF and UDM. This new service operation may be initiated by the UDM or AMF.
5. Included within the AUSF or UDM NF profile registered in NRF and provided to the AMF during AUSF or UDM discovery. The NF profile could include the HN authentication policy itself, or an indication that a HN authentication policy applies so that the AMF can then fetch it from UDM (e.g., via Nudm_SDM_Get or a new service operation).

Depending on the method used, the HN authentication policy provided to the AMF can apply either at HPLMN level or on a per UE basis (i.e., different UEs of the HPLMN may be use different HN authentication policies).

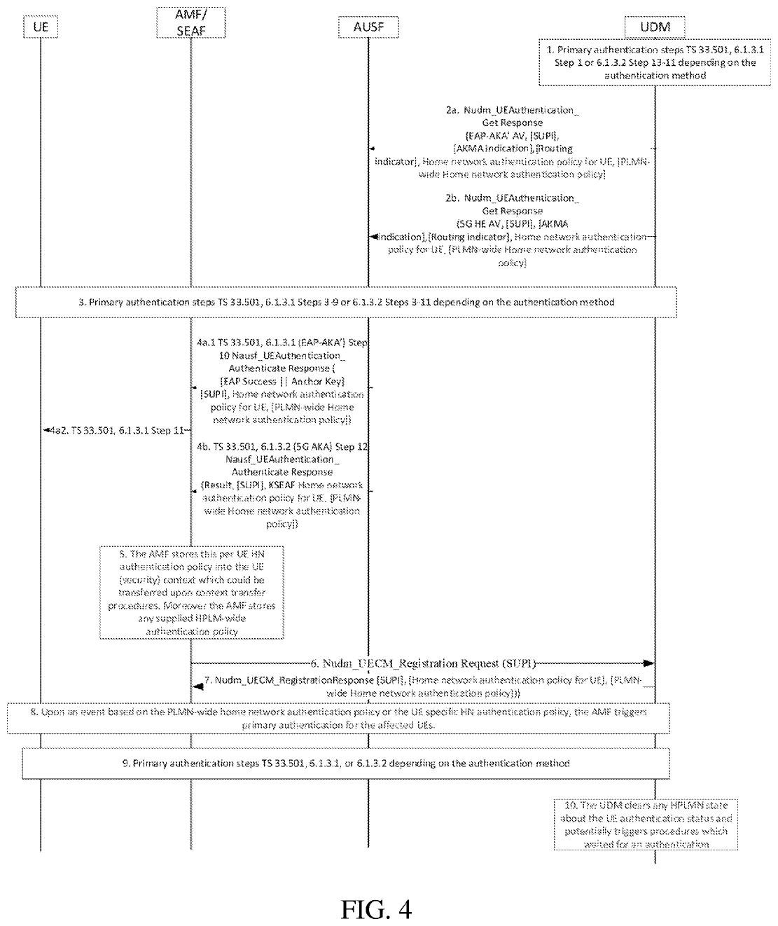

FIG. 4 shows some (1,2) of these options. FIG. 4 illustrates a flow-chart of UDM Triggered primary authentication after UE Registration. The method can include the following steps:
1. Primary authentication step 1 in TS 33.501 [1], 6.1.3.1, or Step 1 in TS 33.501 [1], 6.1.3.2.
2. 2a (EAP-AKA'), 2b (5G AKMA): UDM sends authentication vectors to the AUSF a part of the authentication procedure Step 2 in TS 33.501, 6.1.3.1 and 6.1.3.2 depending on the authentication method (EAP-AKA', 5G AKA). The UDM includes a per-UE and potentially a HPLMN-wide authentication policy. The authentication policy could indicate for example when the next authentication for the specific UE could be (a per UE policy) or the maximum time the HPLMN waits before initiating primary authentication itself (HPLMN-wide policy). The policy information could also indicate the use case for which the HPLMN could trigger primary authentication e.g., interworking, SoR/UPU counter wrap-around, AKMA. The AUSF could provide this policy to the AAnF in a later AKMA procedure step in order for the AAnF to determine the KAF expiry time.
3. Legacy primary authentication steps with 5G AKA or EAP-AKA′ methods.
4. 4a.1, 4a.2, 4b: The last step(s) of the authentication procedure (depending on the authentication method) are enhanced to include information from the AUSF) to the AMF/SEAF related to the Home network authentication policy (per-UE or HPLMN-wide).
5. The AMF stores the per-UE HN authentication policy into the UE (security) context which could be transferred upon context transfer procedures. Moreover, the AMF stores any supplied HPLM-wide authentication policy.
6. The AMF registers to the UDM as the AMF serving the UE. This is legacy procedure
7. The Home Network (e.g., UDM) could also send the per-UE authentication policy and potentially the HPLMN-wide authentication policy as a response to the previous AMF registration request.
8. This step can take place if the there is a per-UE authentication policy or HPLMN-wide authentication policy which triggers the AMF to perform primary authentication e.g., a timer in the authentication policy. The AMF performs single UE or bulk UE authentication in case the HPLMN-wide policy triggers authentication for multiple UEs.
9. The legacy primary authentication takes place.
10. The UDM marks the UE(s) as authenticated in the respective per-UE policies and triggers other procedures which waited for the authentication.

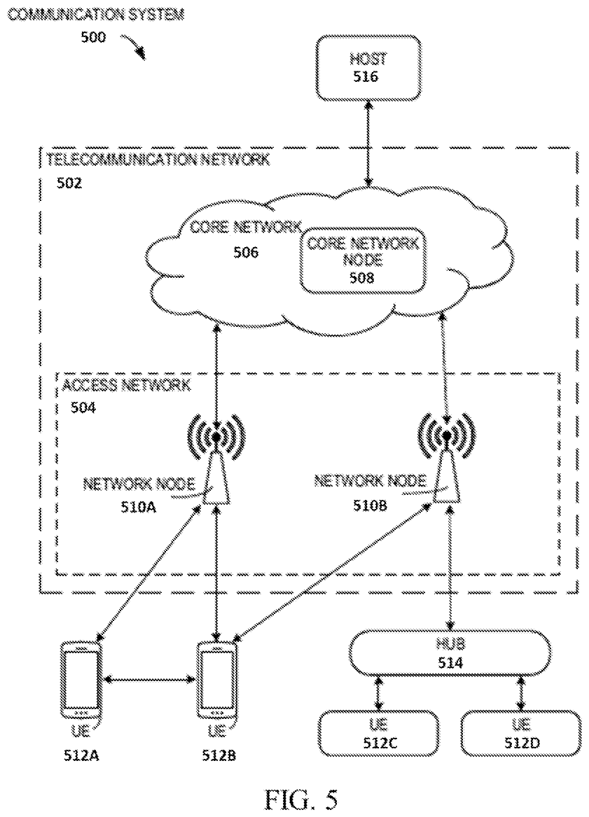

FIG. 5 shows an example of a communication system 500 in accordance with some embodiments.

In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3rd Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub-that is, a hub whose primary function is to route communications to/from the UEs from/to the network node 510b. In other embodiments, the hub 514 may be a non-dedicated hub-that is, a device which is capable of operating to route communications between the UEs and network node 510b, but which is additionally capable of operating as a communication start and/or end point for certain data channels.

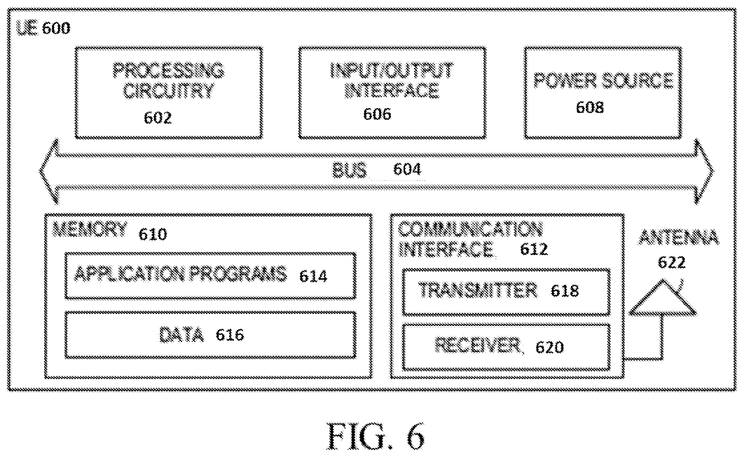

FIG. 6 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

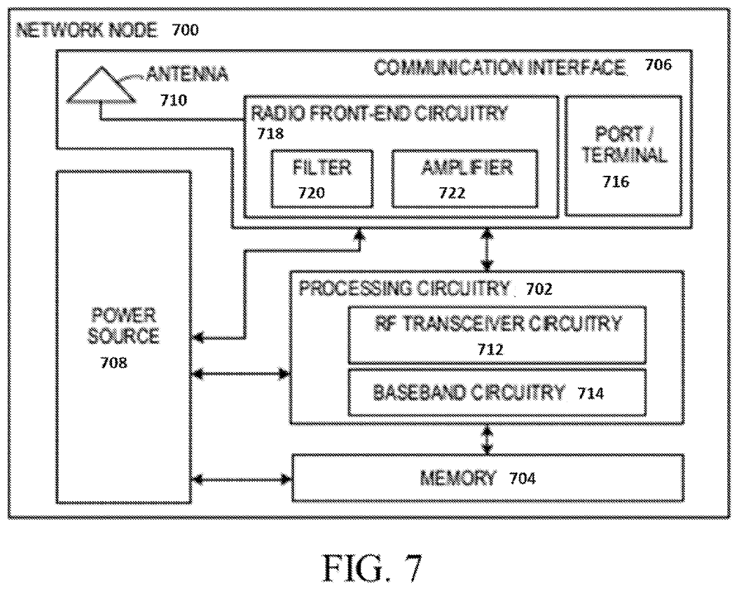

FIG. 7 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

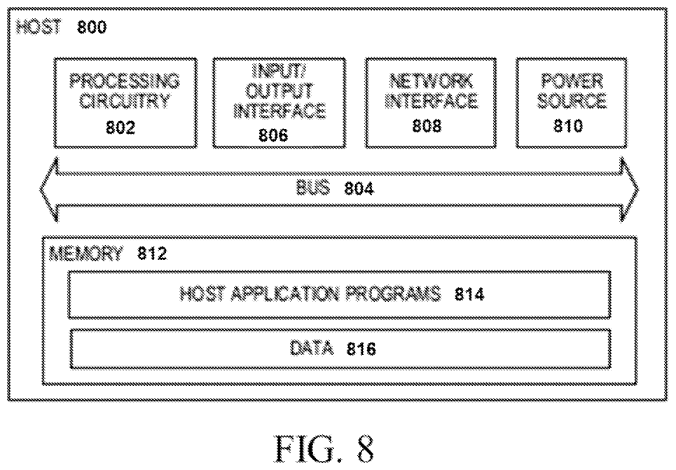

FIG. 8 is a block diagram of a host 800, which may be an embodiment of the host 516 of FIG. 5, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

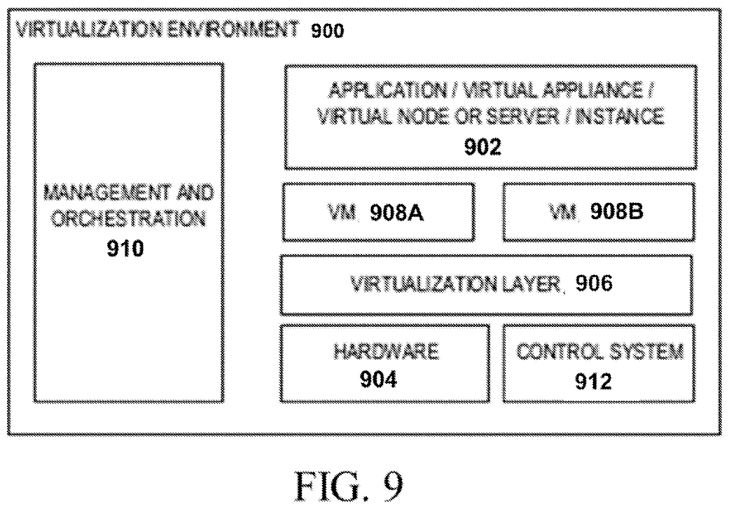

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV).

NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization.

Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

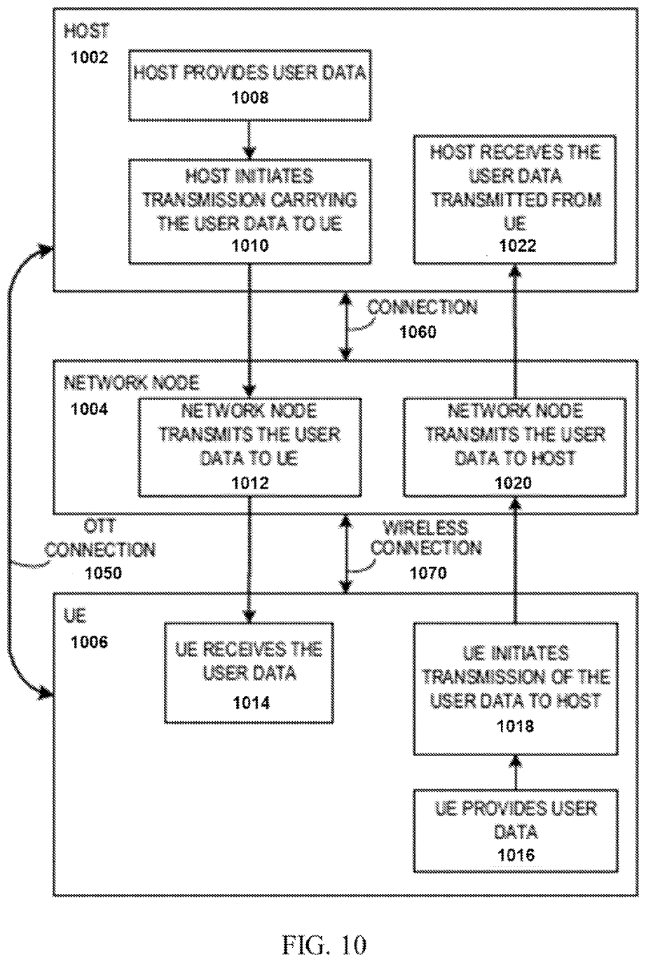

FIG. 10 shows a communication diagram of a host 1002 communicating via a network node 1004 with a UE 1006 over a partially wireless connection in accordance with some embodiments. Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure.

Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve the data rate, latency, or power consumption and thereby provide benefits such as reduced user waiting time, relaxed restriction on file size, improved content resolution, better responsiveness, or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a Unified Data Management (UDM), comprising:
determining that a user equipment (UE) has been registered in the UDM by an Access and Mobility Management Function (AMF);
in response to the determination, sending a request message to the AMF to initiate a primary authentication procedure for the UE, wherein the request message includes a subscription permanent identifier (SUPI) associated with the UE; and
receiving a response message from the AMF based on the request message, wherein the response message indicates an authentication status of the UE.

2. The method of claim 1, wherein the request message comprises a re-authentication notification.

3. The method of claim 1, wherein the request message further comprises a per-UE authentication policy.

4. The method of claim 1, wherein the response message indicates whether the UE is reachable by the AMF.

5. The method of claim 1, further comprising performing operations for the primary authentication procedure.

6. The method of claim 1, wherein the UDM determines to initiate the primary authentication based on a Home Network policy.

7. The method of claim 1, wherein the UDM determines to initiate the primary authentication in response to determining that the UE is not already engaged in a primary authentication procedure.

8. The method of claim 1, wherein the UDM is associated with a 5G Core (5GC), and the UE is a 5G compliant UE.

9. A Unified Data Management (UDM), comprising:
processing circuitry, memory, and transceiver circuitry collectively configured to perform operations, comprising:
determining that a user equipment (UE) has been registered in the UDM by an Access and Mobility Management Function (AMF);
in response to the determination, sending a request message to the AMF to initiate a primary authentication procedure for the UE, wherein the request message includes a subscription permanent identifier (SUPI) associated with the UE; and
receiving a response message from the AMF based on the request message, wherein the response message indicates an authentication status of the UE.

10. The UDM of claim 9, wherein the request message comprises a re-authentication notification.

11. The UDM of claim 9, wherein the request message further comprises a per-UE authentication policy.

12. The UDM of claim 9, wherein the response message indicates whether the UE is reachable by the AMF.

13. The UDM of claim 9, wherein the operations further comprise performing operations for the primary authentication procedure.

14. The UDM of claim 9, wherein the UDM determines to initiate the primary authentication based on a Home Network policy.

15. The UDM of claim 9, wherein the UDM determines to initiate the primary authentication in response to determining that the UE is not already engaged in a primary authentication procedure.

16. A method of operating an Access and Mobility Management Function (AMF), comprising:
receiving a request message from a Unified Data Management (UDM) to initiate a primary authentication procedure for a user equipment (UE), wherein the request message includes a subscription permanent identifier (SUPI) associated with the UE;
determining whether to perform the primary authentication procedure; and
sending a response message to the UDM based on the request message, wherein the response message indicates an authentication status of the UE.

17. The method of claim 16, wherein the request message comprises a re-authentication notification.

18. The method of claim 16, wherein the request message further comprises a per-UE authentication policy.

19. The method of claim 16, wherein determining whether to perform the primary authentication procedure comprises determining whether the UE is reachable by the AMF.

20. The method of claim 16, wherein determining whether to perform the primary authentication procedure comprises inspecting a mark indicating whether the UE is to be authenticated.

21. The method of claim 16, further comprising, upon determining that the primary authentication procedure is to be performed, initiating primary authentication with the UE, and thereafter sending the response message to the UDM to indicate the authentication status of the UE.

22. An Access and Mobility Management Function (AMF), comprising:
processing circuitry, memory and transceiver circuitry, collectively configured to perform operations comprising:
receiving a request message from a Unified Data Management (UDM) to initiate a primary authentication procedure for a user equipment (UE), wherein the request message includes a subscription permanent identifier (SUPI) associated with the UE;
determining whether to perform the primary authentication procedure; and
sending a response message to the UDM based on the request message, wherein the response message indicates an authentication status of the UE.

23. The AMF claim 22, wherein the request message comprises a re-authentication notification.

24. The AMF of claim 22, wherein the request message further comprises a per-UE authentication policy.

25. The AMF of claim 22, wherein determining whether to perform the primary authentication procedure comprises determining whether the UE is reachable by the AMF.

26. The AMF of claim 22, wherein determining whether to perform the primary authentication procedure comprises inspecting a mark indicating whether the UE is to be authenticated.

27. The AMF of claim 22, wherein the operations further comprise, upon determining that the primary authentication procedure is to be performed, initiating primary authentication with the UE, and thereafter sending the response message to the UDM to indicate the authentication status of the UE.
